(19) United States
(12) Patent Application Publication
(10) Pub. No.: US 2012/0144321 A1
(43) Pub. Date: Jun. 7, 2012

(54) APPARATUS, SYSTEM AND METHOD FOR REAL-TIME INTERACTION WITH THIRD-PARTY WEB BROWSING

(76) Inventor: Chad Steelberg, Newport Beach, CA (US)

(21) Appl. No.: 13/295,519

(22) Filed: Nov. 14, 2011

Related U.S. Application Data
(60) Provisional application No. 61/412,989, filed on Nov. 12, 2010.

(51) Int. Cl. G06F 3/01; G06F 15/16

(52) U.S. Cl. 715/760

(57) ABSTRACT

The present invention is and includes a device, system and method for providing at least one coded software item that may be used to track and report both real time and historical browser activities to a third party. Such tracking may include, for example, each and every URL encountered by the browser for the purpose of syndicating to others a feed based on such browsing. The tracking may include temporal characteristics of the browsing done by a user of the browser, the attributes of the user, and/or the attributes of the device from which the browsing has or is taking place.

### CROSS-REFERENCE TO RELATED APPLICATION

The present invention claim priority to U.S. Provisional Application No. 61/412,989, filed Nov. 12, 2010, entitled Apparatus, System And Method For Real-Time Interaction With Third-Party Web Browsing and is incorporated herein by reference as if set forth in its entirety.

### BACKGROUND OF THE INVENTION

### Field of the Invention

The present invention is directed to web browsing and, more particularly, to an apparatus, system and method for a monitoring, tracking and interacting with third-party web browsing.

### SUMMARY OF THE INVENTION

The present invention is and includes a device, system and method for providing at least one coded software item that may be used to track and report both real time and historical browser activities to a third party. Such tracking may include, for example, each and every URL encountered by the browser for the purpose of syndicating to others a feed based on such browsing. The tracking may include temporal characteristics of the browsing done by a user of the browser, the attributes of the user, and/or the attributes of the device from which the browsing has or is taking place.

### BRIEF DESCRIPTION OF THE DRAWINGS

Understanding of the disclosure will be facilitated by consideration of the following detailed description of the embodiments, taken in conjunction with the accompanying drawings, in which like numerals refer to like parts and in which:

FIG. 1 is a diagram that illustrates the tracking widget system in accordance with the present invention;

FIG. 2 is a diagram that illustrates the tracking widget system in accordance with the present invention;

FIG. 3 is a screen shoot that illustrates the tracking widget system in accordance with the present invention;

FIG. 4 is a screen shoot that illustrates the tracking widget system in accordance with the present invention;

FIG. 5 is a screen shoot that illustrates the tracking widget system in accordance with the present invention; and

FIG. 6 is an illustration of the graphical user interface of the tracking widget system in accordance with the present invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in typical computing apparatuses, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

In an embodiment of the present invention, a cookie, widget, or similar coded software item may be used to track and report both real time and historical browser activities. Such tracking may include, for example, each and every URL encountered by the browser for the purpose of syndicating to others a feed based on such browsing. The tracking may include temporal characteristics of the browsing done by a user of the browser, the attributes of the user, and/or the attributes of the device from which the browsing has or is taking place. Thus, tracking of browser use may be inclusive of mobile and semi-mobile computing devices.

Unless specifically stated otherwise, the use of terms such as “processing”, “computing”, “calculating”, “determining”, “displaying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

A computer readable medium may include any mechanism for storing or transmitting information in a form readable by a machine (e.g., a computer). By way of non-limiting example only, a machine-readable medium may include a machine readable storage medium (e.g., read only memory (“ROM”), random access memory (“RAM”), magnetic disk storage media, optical storage media, flash memory devices, etc.), a machine readable transmission medium (electrical, optical, acoustical or other form of propagated signals (e.g., carrier waves, infrared signals, digital signals), and the like.

In an embodiment of the present invention, the tracking widget may be accessed locally to view the browsing that may have occurred utilizing an associated web browser. Similarly, such a widget may be accessed remotely with or without the knowledge of the user of the browser for which the browsing information may be obtained. In such a case, the accessing third party may view and/or access all of the information gathered by the widget.

For example, a third-party server may access the widget to determine the browsing preferences and activities for at least one user of the browser at a predetermined interval, such as, for example, daily. As would be understood by those in the art, such information may be used to provide targeted advertising to the user of the browser, optimization of bandwidth by a service provider by comparing the temporal bandwidth requirements required by the user versus other bandwidth demands, and/or the providing of targeted content related to the user's browsing habits, for example.

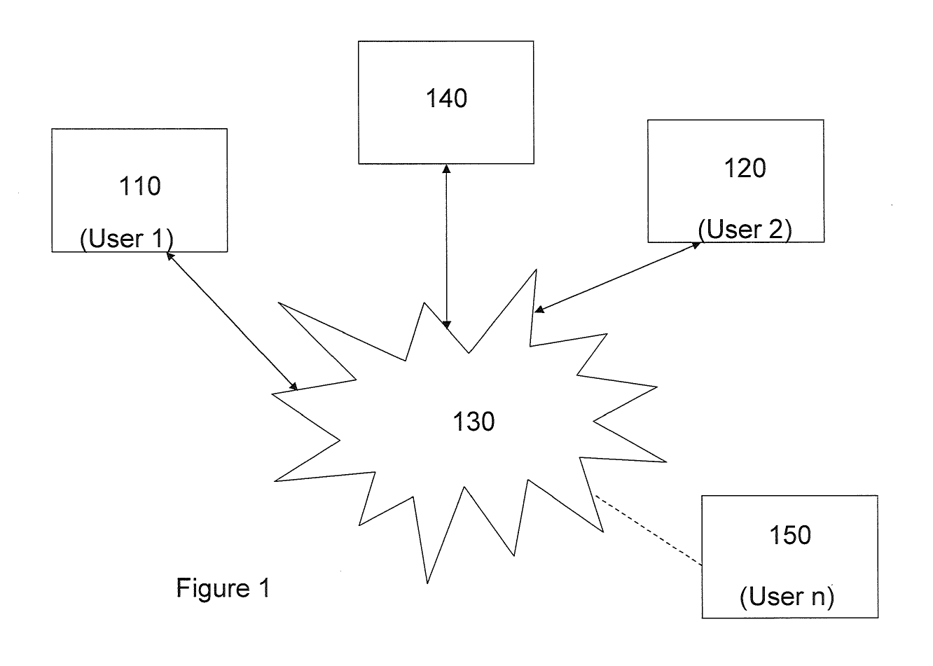

A third party may also include at least one other system user utilizing at least one browser. The at least one third party user may, for example, have access to a system associated widget in real time. Such access may provide the third party user with information regarding the users browsing and/or may allow the third party user to browse simultaneously with the first browsing user, for example. As illustrated in FIG. 1, User 110 may be utilizing a browser in association with a tracking widget of the present invention which may for example the information correspondent to the browsing of User 110 to User 120. Such remote communication regarding the information collected by the tracking widget may be facilitated directly between the users via a communication systems 130. As would be appreciated by those skilled in the art, communication systems 130 may include the internet, a mutually communicative server, and/or wireless communications, for example. In an embodiment of the present invention, user 120 may be able to view the browsing history of user 110 in either a log format showing for example URL addresses, or graphically by allowing the information to facilitate a browser at user 120 to browse and view the tracked browsing of user 110.

In an embodiment of the present invention, the tracking widget may capture at least one screen shot correspondent to at least one web page browsed by at least one user. The tracking widget may further capture a screen shot for each page browsed by the user and may be directed to capture multiple screen shots of a single webpage based on the user's interaction with the viewed webpage.

For example, a tracking widget correspondent to the browser of user 110 may capture a screen shot of every individual page visited or browsed by user 110. This information may be delivered to user 120 for viewing. A receiving widget located at user 120 may receive the data from the tracking widget of user 110 and may allow the user 120 to view the at least one screen shot captured by the tracking widget. User 120 may toggle through the at least one individual image provided by the tracking widget and may also be presented with attributes of the user and the browsing done by the user such as, for example, the name of the person browsing, the time at which the screen shot was captured, and/or the duration of time the user spent browsing the webpage depicted in the screen capture.

The present invention may also provide a server 140 which may act as a collection and/or retrieval point, for example, which may facilitate the collection and consolidation of selected tracking widgets. Thus, a third party may instruct server 140 to extract data from any number of users whether specifically predetermined and/or a match for predetermined attributes. In this way, server 140 may allow for the capture of multiple feeds which may be viewed by at least one third party historically and/or in real time.

In an embodiment of the present, invention server 140 is local to a third party user. By way of non-limiting example only, user 120 may be utilizing a television equipped to communicate with server 140 and may have the ability to view the information provided via a collection widget correspondent to a browser at user 110. In this way, a minor child browsing the worldwide web on a computer located in a bedroom may have his or her browsing inspected by a parent sitting in a living room watching the television. Such parental inspection may occur at any time during the child's use of the browser, and may occur in real time. Similarly, the parent may program the viewing enabled television to update and/or refresh the third party view of the browsing at a predetermined interval. The information communicated to the parent may also come in the form of an alert. Such an alert may indicate that the browsing has changed locations, such as a change in the root URL, and/or has landed on a URL which has been predetermined to cause an alert to at least one third party.

The viewing by a third party of the tracked browsing may occur on any communication enabled device such as a mobile phone, wireless computer, and/or a television. It is contemplated in the present invention that even if a television is not directly connected to the internet or otherwise directly enabled to receive information from the tracking widget, such capability may be provided by a third party service provider such as, for example, a cable television operator. For example, such a service provider may be authorized to track the browsing of a particular user and may provide information or an alert, as described above, to an authorized requesting user of the service provider.

In an embodiment of the present invention, at least two distinct tracking widgets may be viewed by a single third party at one time. Such information may be viewed as described above and may be preferably viewed in a split screen format such that the at least two information streams may be visually presented to the third party.

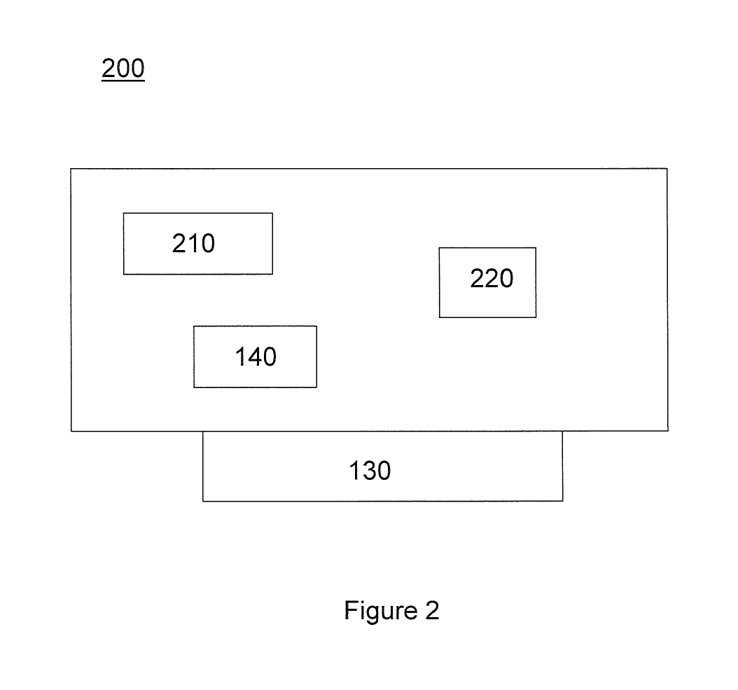

As illustrated in FIG. 2, an exemplary network architecture 200 may operate with embodiments of the present invention. The network architecture 200 may include a user device 210, a server 140, an anonymous proxy 220 and a network 130. The user device 210, the server 140 and the anonymous proxy 220 may be coupled to the network 130, which may be a public network (e.g., Internet) or a private network (e.g., an ethernet or a local area Network (LAN)), for example.

In one embodiment, server 140 may be a web server that provides text, images and other information in the form of one or more web pages. The server 140 may accept user requests for content (e.g., hyper text transfer protocol (HTTP) requests) from user device 210, and reply by sending responses (e.g., HTTP responses), which may include information pertaining to web pages.

The user device 210 may be, for example, a personal computer (PC), mobile phone, palm-sized computing device, personal digital assistant (PDA), and the like. The user device 210 may include a browser, as described hereinabove. The browser may be an application that enables the user device 210 to display and interact with text, images, and other information provided by the server 140. In an embodiment of the present invention, the browser may be a web browser configured to display web pages.

A browser may receive user requests for content and send the requests to server 140. In an embodiment of the present invention, a user request for content may be sent to the server 140 to access one or more web pages via the network 130. User requests for content may also be sent to the server 140 to initiate the functionality of the tracking widget. For example, a user request for content may be sent to the server 140 to initiate a tracking function, to obtain browsing information from at least one unique tracking widget.

For example, a user request for content may be sent to server 140 and may include user identifying information. The user identifying information may be information that may be used to track user browsing behavior, to determine user preferences, and possibly, to ultimately identify a user. In addition to the examples provided above, user identifying information may include an IP address, cookies, and the like.

In an embodiment of the present invention, identifying information may be filtered out, and may be based on a user profile or user preferences. User preferences may include, for example, browsing preferences, search preferences, commerce preferences, and the like. Default user preferences may be provided by the browser if no user preferences are available. Further, a user profile may include user preferences, as well as additional user information, such as user age, for example. In an embodiment of the present invention, a user below a specific age may have associated with them additional context criteria apply. Such information may control, in part, the access provided to third parties with respect to such user profile and/or tracked information.

A user may select the criteria under which to filter out each type of user identifying information. Alternatively, a user may select a privacy setting from multiple privacy settings, each applying different context criteria under different circumstances. Thus, user identifying information may be fully filtered or only partially filtered. For example, when user identifying information is partially filtered, cookies and a referrer header may be filtered out, but an IP address may not be filtered. Some user identifying information can be filtered out simply by not sending the information (e.g., cookies and referrer headers).

In an embodiment of the present invention, the anonymous proxy 220 may be used to filter out user identifying information. If no filtering is being performed, a user request for content may be sent directly to server 140. However, by directly sending a request for content to server 140, the browser may, at a minimum, identify an IP address of the user device 210 to the server 140.

In an embodiment of the present invention, the anonymous proxy 220 may be a proxy server that may act as an intermediate destination to which the user request for content may be forwarded. Alternatively, the anonymous proxy 220 may be a distributed proxy service that includes multiple proxy servers. A user request for content may be forwarded among the multiple proxy servers before being sent to server 140 and may facilitate the receiving by a user of information related to at least two user requests, for example.

In an embodiment of the present invention, the tracking widget may include forwarding logic. The forwarding logic may forward content to the anonymous proxy 220 when directed by a user request. For example, the forwarding logic may forward content to the anonymous proxy 220 when a user request is received from at least one user communicatively connected to the network 130.

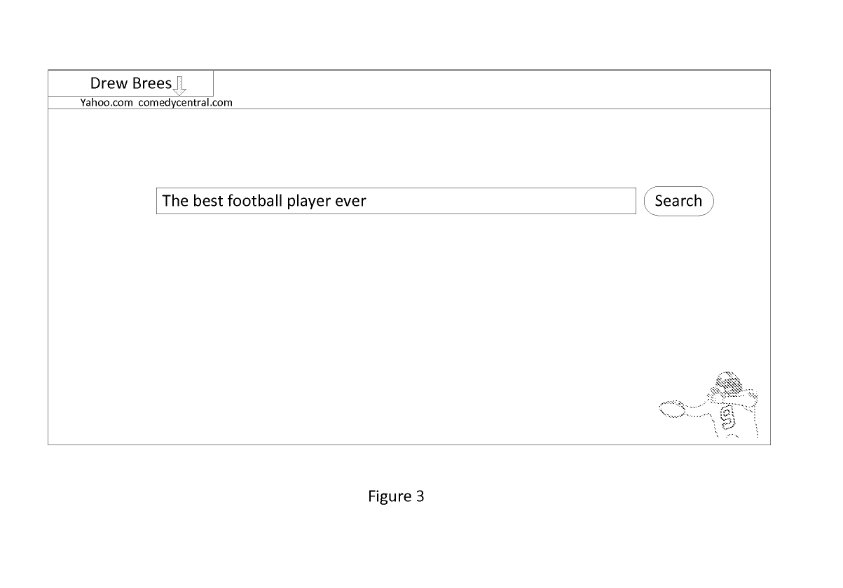

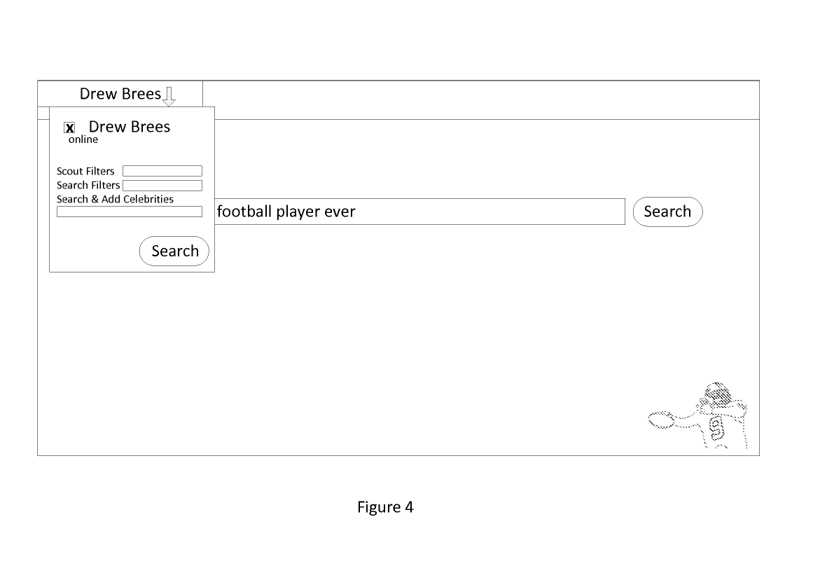

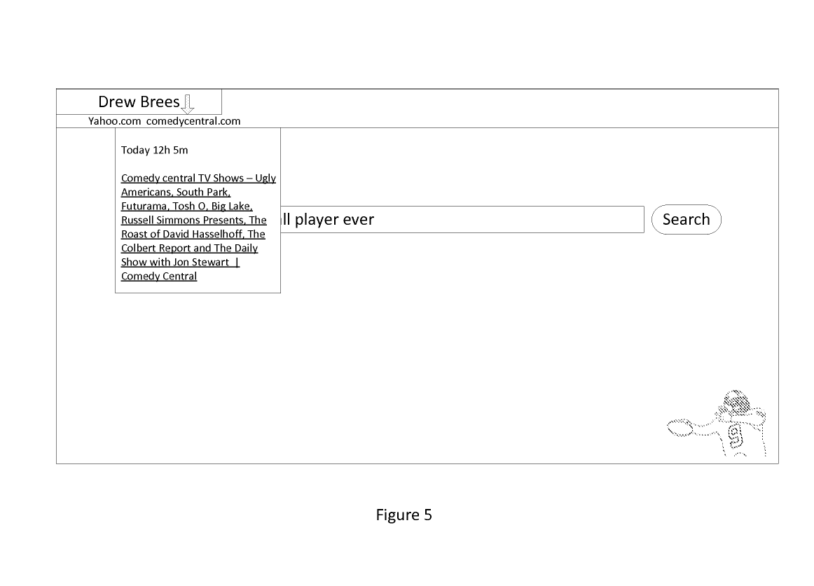

As illustrated in FIG. 3, a graphical user interface (GUI) may be provided by the tracking widget and may include at least one indication that the tracking widget is active. The GUI may also provide at least one source indication related to third party information. For example, and as illustrated in FIG. 4 and FIG. 5, an image representing the source and/or a menu link may be provided.

In an embodiment of the present invention, information created by one user may be syndicated to multiple users of the tracking widget. For example, a tracking widget may provide access to the browsing information of a popular sports athlete to multiple users of the present invention. As described above, the information available to a user of the system may be presented in a variety of ways and may be filtered and/or organized according to various attributes, including, but not limited to, the type of device the information is compatible with, the volume of information available, and the bandwidth required to access the information, and like attributes, for example.

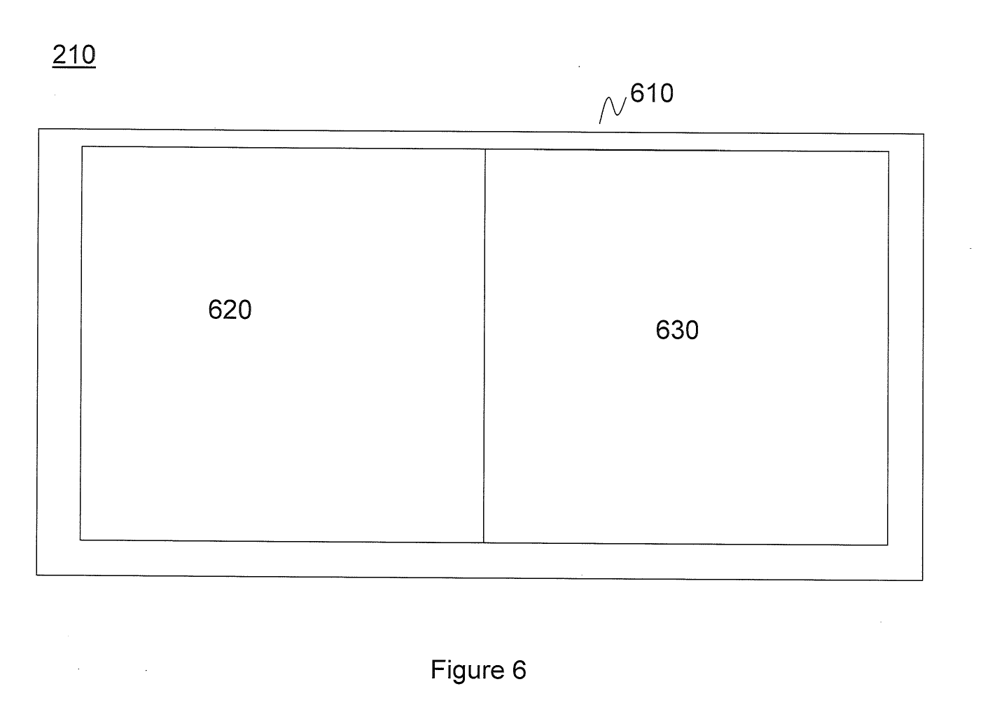

As illustrated in FIG. 6, the GUI may also, as more fully described above, provide access to multiples of information accepted by the user. For example, syndicated information in the form of real-time web browsing by a celebrity may be shown on portion one 620 of the GUI with the historical browsing information related to a related minor child displayed on portion two 630 of the GUI. As would be appreciated by those skilled in the art, the portions may be manipulated, multiplied, and terminated as permitted by the constraints of the device on which the GUI is resident. A celebrity, for the sake of clarity, may be any individual, animal, and/or object familiar to at least 1,000 people during at least one moment in time.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention.

What is claimed is:

1. A system for monitoring internet activity, comprising:
a non-transitory computer readable storage medium having encoded thereon computer executable instructions for a first tracking widget communicatively coupled with a first browser comprising at least one computerized memory communicatively associated with at least one processor programmed to provide browsing information from the first browser to at least one collection point,
a non-transitory computer readable storage medium having encoded thereon computer executable instructions for at least one second tracking widget communicatively coupled with at least one second browser comprising at least one computerized memory communicatively associated with at least one processor programmed to receive browsing information from the at least one collection point;
wherein the information provided by the first tracking widget allows the at least one second browser to display the information as displayed by the first browser.

2. The system of claim 1, wherein the first browser is remote from the second browser.

3. The system of claim 1, wherein the information displayed by the at least one second browser is with a new window.

4. The system of claim 1, wherein the information displayed by the at least one second browser includes real-time browsing within the first browser.

5. The system of claim 1, wherein the information displayed by the at least one second browser is time-delayed.

6. The system of claim 1, wherein the information displayed by the at least one second browser is displayed at a predetermined time.

7. The system of claim 1, wherein the information displayed by the at least one second browser include one selected from the group consisting of a blog, a video, a photo, an interactive chat, an advertisement and a live stream.
